(19) United States
(12) Patent Application Publication
(10) Pub. No.: US 2008/0094337 A1
(43) Pub. Date: Apr. 24, 2008

(54) Method of driving plasma display apparatus

(76) Inventors: Kazuhiro Ito, Suwon-si (KR); Nam-Sung Jung, Suwon-si (KR); Ki-Ho Shin, Suwon-si (KR); Tae-Wook Kim, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/907,995

(22) Filed: Oct. 19, 2007

(30) Foreign Application Priority Data
Oct. 23, 2006 (KR) 10-2006-0103140
Dec. 20, 2006 (KR) 10-2006-0130827

(51) Int. Cl. G09G 3/36

(52) U.S. Cl. 345/97

(57) ABSTRACT

A method of driving a plasma display apparatus may include supplying a first voltage to the X electrodes during a first reset period of the reset period, supplying, using energy stored in the energy recovery circuit, a ramp waveform voltage that rises from the first voltage signal to a second voltage to the X electrodes during a second reset period of the reset period, biasing the X electrodes with the second voltage during at least a first sub-period of a third reset period of the reset period, supplying a ramp pulse waveform voltage that rises from a third voltage to a fourth voltage to the Y electrodes during a second portion of the first reset period, and supplying a ramp pulse waveform voltage that falls from the third voltage to a fifth voltage to the Y electrodes during the third reset period.

### BACKGROUND OF THE INVENTION

1. Field of the Invention

Embodiments of the invention relate to methods of driving a plasma display apparatus. More particularly, embodiments of the invention relate to methods of driving a plasma display apparatus capable of reducing reactive power consumption and electromagnetic interference (EMI).

2. Description of the Related Art

Plasma display panels (PDPs) are generally flat display devices that have a wide screen, and display a desired image by applying a discharge voltage between two substrates, which each have a plurality of electrodes. Discharge gas may be entrapped between the two substrates and may be used to generate ultraviolet rays that excite a phosphor pattern.

An apparatus for driving a PDP may include a plurality of power sources, a plurality of switching devices, and a plurality of driving integrated circuits (ICs), which control switching operations of the switching devices in order to apply driving signals to each of a plurality of electrodes disposed in the PDP. The apparatus for driving the PDP may output the driving signals according to switching operations of the plurality of switching devices.

An energy recovery circuit is also generally included in apparatuses for driving the PDP, which generally consume a great amount of driving power. In general, displacement current corresponding to reactive power flows in each cell of an AC type PDP when discharge sustain pulses are applied to electrodes, and a discharge current immediately flows in each cell when a wall voltage and an external voltage exceeds a discharge firing voltage so that a plasma discharge is generated. When a predetermined voltage is applied to the electrodes, a sustain discharge may be generated in a cell where a predetermined requirement is satisfied by resuming the plasma discharge. Although discharge current does not flow in a cell where the predetermined requirement is not satisfied, displacement current may flow in the cell. An amount of displacement current may depend on an intrinsic capacitance that varies according to a type or a component of each pixel. Intrinsic capacitance generally consumes a great amount of reactive power. The energy recovery circuit may reduce reactive power consumption.

The energy recovery circuit may be included in an X electrode driver and a Y electrode driver. When a sustain pulse for a display discharge is cyclically applied to X electrode lines and Y electrode lines during a sustain period, which may include a plurality of subfields for displaying a time division gray scale, the energy regenerating circuit may recover power unnecessary for discharge cells that are displayed during a current pulse period and may apply the recovered power to discharge cells that are to be displayed during a next pulse period.

An energy regenerative circuit capable of reducing the reactive power consumption during a reset period and/or an address period is desired.

### SUMMARY OF THE INVENTION

Embodiments of the present invention are therefore directed to methods of driving a plasma display apparatus, which substantially overcome one or more of the problems due to the limitations and disadvantages of the related art.

It is therefore a feature of an embodiment of the invention to provide a method of driving a plasma display apparatus in which an amount of a hard switching current corresponding to a voltage applied to X electrodes during a reset period and/or an address period may be reduced.

It is therefore a separate feature of an embodiment of the invention to provide a method of driving a plasma display apparatus in which an amount of reactive power consumption and/or electromagnetic interference (EMI) may be reduced.

At least one of the above and other features and advantages of the present invention may be realized by providing a method of driving a plasma display apparatus to display an image during a frame including a plurality of subfields, each subfield including a reset period, an address period and a sustain period, the display apparatus including a panel including X and Y electrodes, an electrode driver adapted to supply driving signals the X and Y electrodes and including an energy recovery circuit, the method including supplying a first voltage to the X electrodes during a first reset period of the reset period, supplying, using energy stored in the energy recovery circuit, a ramp waveform voltage that rises from the first voltage signal to a second voltage to the X electrodes during a second reset period of the reset period, biasing the X electrodes with the second voltage during at least a first sub-period of a third reset period of the reset period, supplying a ramp pulse waveform voltage that rises from a third voltage to a fourth voltage to the Y electrodes during a second portion of the first reset period, and supplying a ramp pulse waveform voltage that falls from the third voltage to a fifth voltage to the Y electrodes during the third reset period.

The method may include supplying the first voltage to the Y electrodes during a first portion of the first reset period that precedes the second portion of the first reset period. The method may include supplying the third voltage to Y electrodes during the second reset period. The energy recovery circuit may include an energy storage unit that stores charges of the panel, a first switching device adapted to controllably supply the charges stored in the energy storage unit to the panel, and a second switching device adapted to controllably supply the charges stored in the panel to the energy storage unit, and the method may further include turning on the first switching device during the second reset period.

The electrode driver may include a first voltage source, a third switching device that is connected to the first voltage source and controls a supply of the first voltage to the X electrodes, a second voltage source, and a fourth switching device connected to the second voltage source and controls a supply of the second voltage the X electrodes, and the method may include turning off the fourth switching device during the first and second reset periods, and turning on the fourth switching device during the third reset period.

The address period may include a first address period during which the X electrodes are biased with the second voltage, and a second address period, and the method may further include supplying, during the second address period and using the energy recovery circuit, a ramp waveform voltage that falls from the second voltage to the first voltage to the X electrodes.

The energy recovery circuit may include an energy storage unit that stores charges of the panel, a first switching device adapted to controllably supply the charges stored in the energy storage unit to the panel, and a second switching device adapted to controllably supply the charges stored in the panel to the energy storage unit, and the method may include turning on the second switching device during the second reset period.

The second switching device may be turned on during an initial portion of the sustain period when the first voltage is being applied to the Y electrodes. The electrode driver may include a first voltage source, a third switching device that is connected to the first voltage source and controls a supply of the first voltage to the X electrodes, a second voltage source, and a fourth switching device connected to the second voltage source and controls a supply of the second voltage to the X electrodes, and the method may further include turning off the third switching device during the address period, turning on the third switching device during a second initial predetermined portion of the sustain period, turning on the fourth switching device during a predetermined portion of the first address period, and turning off the fourth switching device before completion of the first address period, and maintaining the fourth switching device in an off state through a remainder of the first address period, the second address period, and the sustain period.

The second initial predetermined portion of the sustain period may be a period during which the first voltage is applied to the X electrodes. The method may include maintaining the X electrodes in an electrically floating state during a second sub-period of the third reset period. Maintaining the X electrodes in an electrically floating state may include not supplying a voltage to the X electrodes during the second sub-period of the third reset period.

The energy recovery circuit may include an energy storage unit that stores charges of the panel, and a switching device adapted to controllably supply the charges stored in the energy storage unit to the panel, and the method may include turning on the switching device during the second reset period.

The method may include maintaining the X electrodes in the electrically floating state during an initial predetermined portion of the address period. The electrode driver may include a switching device connected to a second voltage source and adapted to control a supply of the second voltage to the X electrodes, and the method may include turning off the switching device during the first reset period, the second reset period, and the second sub-period of the third reset period.

The method may include supplying the third voltage to the Y electrodes during an initial predetermined portion of the first sub-period of the third reset period, the initial predetermined portion of the first sub-period of the third reset period immediately following the second reset period.

Supplying the ramp pulse waveform voltage that falls from the third voltage to the fifth voltage comprises supplying the ramp pulse waveform voltage that falls from the third voltage to the fifth voltage during the first sub-period and the second sub-period of the third reset period, and the method may include, during the address period, supplying a scan pulse having a seventh voltage to the Y electrodes, which are biased with a sixth voltage, and supplying the second voltage to the X electrodes after the initial predetermined portion of the address period.

At least one of the above and other features and advantages of the present invention may be realized by providing a method of driving a plasma display apparatus to display an image during a frame including a plurality of subfields, each subfield including a reset period, an address period and a sustain period, the address period including a first address period and a second address period, the display apparatus including X and Y electrodes, an electrode driver adapted to supply driving signals the X and Y electrodes and including an energy recovery circuit, the method including biasing the X electrodes with a biasing voltage during the first address period, and supplying, during the second address period and using the energy recovery circuit, a ramp waveform voltage that falls from the biasing voltage to a first voltage to the X electrodes.

At least one of the above and other features and advantages of the present invention may be realized by providing a method of driving a plasma display apparatus to display an image during a frame including a plurality of subfields, each subfield including a reset period, an address period and a sustain period, the address period including a first address period and a second address period, the display apparatus including X electrodes, an electrode driver adapted to supply driving signals the X electrodes and including an energy recovery circuit, the method may include supplying a first voltage to the X electrodes during a first reset period of the reset period, and at least one of supplying, using energy stored in the energy recovery circuit, a ramp waveform voltage that rises from the first voltage signal to a second voltage to the X electrodes during a second reset period of the reset period, and biasing the X electrodes with the second voltage during at least a portion of the first address period, and supplying, during the second address period and using the energy recovery circuit, a ramp waveform voltage that falls from the second voltage to a first voltage to the X electrodes.

The method may include biasing the X electrodes with the second voltage during at least a portion of a third reset period of the reset period.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a diagram of a plasma display panel (PDP), which may be driven by a method according to an embodiment of the present invention;

FIG. 2 illustrates a diagram of an exemplary arrangement of electrodes in the PDP of FIG. 1;

FIG. 3 illustrates a block diagram of an exemplary apparatus for driving the PDP of FIG. 1 according to one or more aspects of the invention;

FIG. 4 illustrates a circuit diagram of an exemplary X driver of the apparatus for driving the PDP illustrated in FIG. 3 according to an exemplary embodiment of the present invention;

FIG. 5 illustrates a circuit diagram of an exemplary Y driver of the apparatus for driving the PDP illustrated in FIG. 3 according to an exemplary embodiment of the present invention;

FIG. 6 illustrates a timing and waveform diagram of exemplary driving signals and driving switching signals supplied to electrodes using an exemplary method of driving a plasma display apparatus according to an exemplary embodiment of the present invention;

FIG. 7 illustrates a timing and waveform diagram of exemplary driving signals and driving switching signals supplied to electrodes using an exemplary method of driving a plasma display apparatus according to another exemplary embodiment of the present invention;

FIG. 8 illustrates a timing and waveform diagram of exemplary driving signals and driving switching signals supplied to electrodes using an exemplary method of driving a plasma display apparatus according to another exemplary embodiment of the present invention;

FIG. 9 illustrates a timing and waveform diagram of exemplary driving signals and driving switching signals supplied to electrodes using an exemplary method of driving a plasma display apparatus according to another exemplary embodiment of the present invention;

FIG. 10 illustrates a timing and waveform diagram of exemplary driving signals and driving switching signals supplied to electrodes using an exemplary method of driving a plasma display apparatus according to another exemplary embodiment of the present invention;

FIG. 11A illustrates a graph of a result obtained by measuring an amount of hard switching current corresponding to a second voltage using a conventional method of driving a plasma display apparatus;

FIG. 11B illustrates a graph of a result obtained by measuring an amount of hard switching current corresponding to a second voltage using methods of driving a plasma display apparatus illustrated in FIGS. 6 and 8; and

FIG. 11C illustrates a graph illustrating a result obtained by measuring an amount of hard switching current corresponding to a second voltage using a method of driving a plasma display apparatus illustrated in FIG. 10.

### DETAILED DESCRIPTION OF THE INVENTION

Korean Patent Application No. 10-2006-0103140 filed on Oct. 23, 2006, and No. 10-2006-0130827, filed on Dec. 20, 2006, in the Korean Intellectual Property Office, and entitled: “Method of Driving Plasma Display Apparatus,” is incorporated by reference herein in its entirety.

Embodiments of the present invention will now be described more fully hereinafter with reference to the accompanying drawings, in which exemplary embodiments of the invention are illustrated. Aspects of the invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of regions may be exaggerated for clarity of illustration. Like reference numerals refer to like elements throughout the specification.

Hereinafter, the present invention will be described more fully with reference to the accompanying drawings, in which exemplary embodiments of the invention are shown.

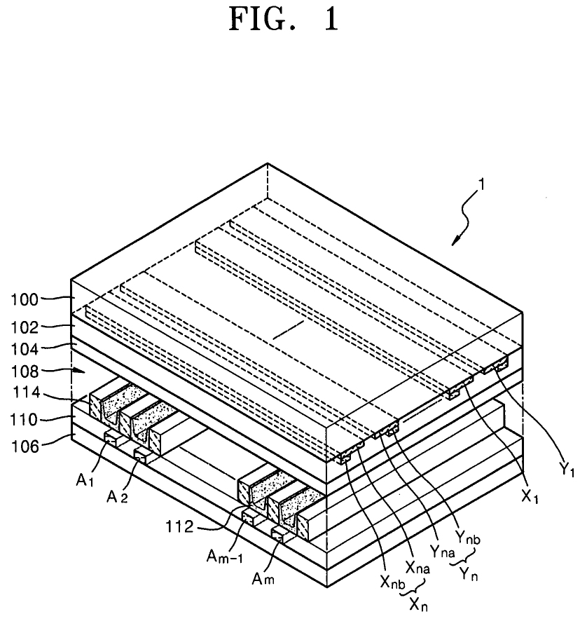

FIG. 1 illustrates a diagram of an exemplary plasma display panel (PDP) 1, which may be driven by a method according to an embodiment of the present invention.

Referring to FIG. 1, the PDP 1 may include A electrodes A1 through Am, a first dielectric layer 102, a second dielectric layer 110, Y electrodes Y1 through Yn, X electrodes X1 through Xn, phosphor layers 112, barrier ribs 114, and a magnesium monoxide (MgO) protective layer 104 between a first substrate 100 and a second substrate 106.

The A electrodes A1 through Am may be arranged in a uniform pattern on the second substrate 106 facing towards the first substrate 100. The second dielectric layer 110 may be coated on the A electrodes A1 through Am. The barrier ribs 114 may be formed on the second dielectric layer 110, and may extend parallel to the A electrodes A1 through Am. The barrier ribs 114 may define a respective discharge area of each discharge cell, and may prevent optical interference between the discharge cells. The phosphor layers 112 are may be on the second dielectric layer 110 on the A electrodes A1 through Am between the barrier ribs 114. Phosphor layers emitting red light, green light, and blue light may be sequentially disposed.

The X electrodes X1 through Xn and the Y electrodes Y1 through Yn may be arranged in a uniform pattern on the first substrate 100 facing toward the second substrate 106, and may be arranged to overlap and cross, e.g., perpendicularly cross, the A electrodes A1 through Am. Each crossing point may be associated with a corresponding discharge cell. Each of the X electrodes X1 through Xn and each of the Y electrodes Y1 through Yn may include transparent electrodes Xna and Yna and metal electrodes Xnb and Ynb. The transparent electrodes Xna and Yna may include a transparent conductive material, e.g., indium tin oxide (ITO), etc, and the metal electrodes Xnb and Ynb may include a material having high conductivity: e.g., metal. The first dielectric layer 102 may coat the X electrodes X1 through Xn and the Y electrodes Y1 through Yn, e.g., may be arranged on the first substrate 100 and may completely and/or substantially completely coat exposed surfaces of the X electrodes X1 through Xn, and the Y electrodes Y1 through Yn. The protective layer 104, for protecting the PDP 1 from strong electric fields, may include, e.g., a MgO layer, and may coat the first dielectric layer 102, e.g., may be arranged on the first dielectric layer 102 and may completely and/or substantially completely coat an entire surface of the first dielectric layer 102. Gas for forming plasma may be sealed in a discharge space 108.

Embodiments of the invention are not limited to the exemplary PDP shown in FIG. 1. That is, embodiments of the invention may be employed to drive other types and/or structures of plasma display devices. For example, the PDP may not have a three-electrode structure as shown in FIG. 1, but may have a two-electrode structure.

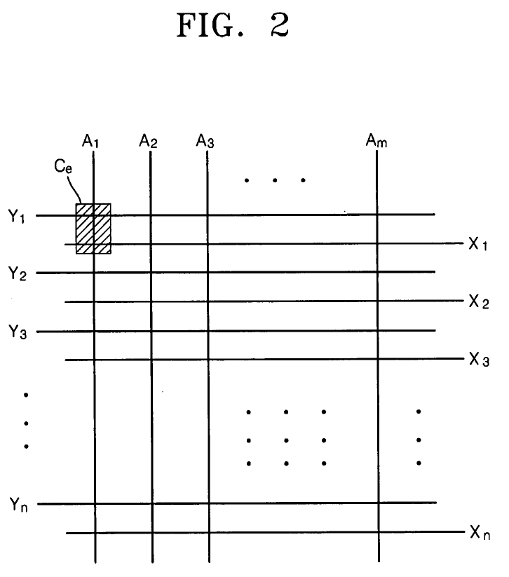

FIG. 2 illustrates a diagram of an exemplary arrangement of electrodes in the PDP of FIG. 1.

Referring to FIG. 2, the Y electrodes Y1 through Yn may be disposed parallel to the X electrodes X1 through Xn, the A electrodes A1 through Am may be disposed to cross the Y electrodes Y1 and Yn and the X electrodes X1 through Xn, and the crossing areas define discharge cells Ce.

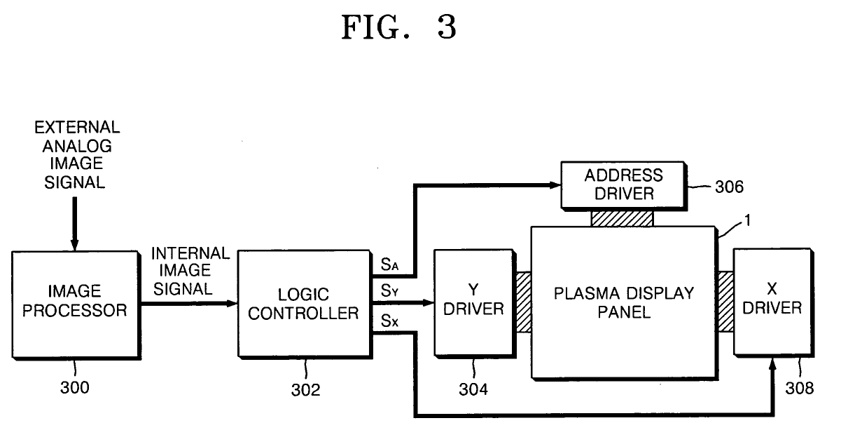

FIG. 3 illustrates a block diagram of an exemplary apparatus for driving the PDP of FIG. 1 according to one or more aspects of the invention.

Referring to FIG. 3, an apparatus for driving the PDP 1 may include an image processor 300, a logic controller 302, a Y driver 304, an address driver 306, and an X driver 308. The image processor 300 may generate internal image signal(s) by converting an external image signal into an internal image signal. The logic controller 302 may generate an address drive control signal S_{A}, a Y drive control signal S_{Y}, and an X drive control signal S_{X} based on the internal image signals of the image processor 300. The Y driver 304, the address driver 306, and the X driver 308 may output a respective address drive signal S_{A}, a respective Y drive signal S_{Y}, and a respective X drive signal S_{X}, respectively, to Y electrodes, A electrodes, and X electrodes based on the address drive control signal S_{A}, the Y drive control signal S_{Y}, and the X drive control signal S_{X}.

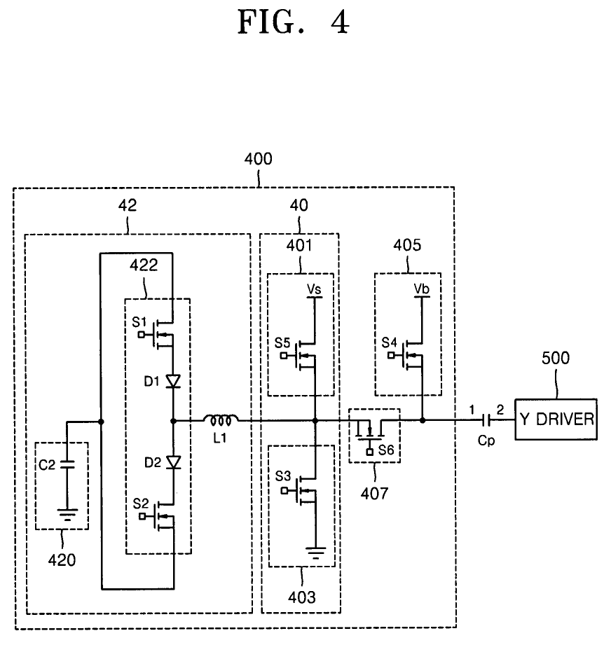

FIG. 4 illustrates a circuit diagram of an exemplary X driver 400 of the apparatus for driving the PDP 1 illustrated in FIG. 3 according to an exemplary embodiment of the present invention.

Referring to FIG. 4, the X driver 400 may include a sustain pulse applying circuit 40, a second voltage applying unit 405, an energy recovery circuit 42, and a switching unit 407, and may output a driving signal to the respective X electrode(s) (first terminal(s) of panel capacitors Cp). The sustain pulse applying circuit 40 may include a first voltage applying unit 403, which may output a first voltage Vg, e.g., a ground voltage, and a ninth voltage applying unit 401, which may output a ninth voltage Vs. The second voltage applying unit 405 may output a second voltage Vb. The energy recovery unit 42 may accumulate charges in the respective panel capacitor Cp or may store charges in the respective panel capacitor Cp.

The first voltage applying unit 403 may include a third switching device S3 having one terminal connected to ground and another terminal connected to the switching unit 407. The ninth voltage applying unit 401 may include a fifth switching device S5 having one terminal connected to a ninth voltage Vs source and another terminal connected to the switching unit 407. The sustain pulse applying unit 40 comprising the first voltage applying unit 403 and the ninth voltage applying unit 401 may alternatively turn on the third switching device S3 and the fifth switching device S5 in order to generate a sustain pulse.

The second voltage applying unit 405 may include a fourth switching device S4 having one terminal connected to a second voltage source, which may supply the second voltage Vb, and another terminal connected to the respective X electrode(s) (the first terminal(s) of the panel capacitors Cp) of the PDP 1 and the switching unit 407. When the fourth switching device S4 is turned on, the second voltage Vb may be output to the respective X electrode(s) (the first terminal(s) of the panel capacitors Cp) of the PDP 1.

The energy recovery unit 42 may include an energy storage unit 420 that stores charges from the respective panel capacitors Cp, an energy recovery switching unit 422 that is connected to the energy storage unit 420, and an inductor L1 having one end connected to the energy recovery switching unit 422 and another end connected to the respective X electrode(s) (the first terminal(s) of the panel capacitors Cp) of the PDP 1. The energy recovery switching unit 422 may control the charges stored in the energy storage unit 420 that are to be accumulated in the panel capacitor Cp or charges of the panel capacitor Cp that are to be stored in the energy storage unit 420.

The energy storage unit 420 may include a second capacitor C2 for storing the charges of the panel capacitor Cp.

The energy recovery switching unit 422 may include a first switching device S1 and a second switching device S2 each having one terminal connected to the energy storage unit 420 and another terminal connected to the inductor L1. First and second diodes D1 and D2 may be connected in different directions relative to the inductor L1 and may be connected between the first switching device S1 and the second switching device S2.

Exemplary operation of the energy recovery unit 42 will be described below. If the second switching device S2 of the energy recovery switching unit 422 is turned on, charges of the respective panel capacitor Cp may be stored in the second capacitor C2 through the inductor L1, the second diode D2, and the second switching device S2. If the first switching device S1 of the energy recovery switching unit 422 is turned on, charges stored in the second capacitor C2 may be accumulated in the panel capacitors Cp through the first switching device S1, the first diode D1, and the inductor L1.

The switching unit 407 may include one terminal connected to the sustain pulse applying unit 40 and another terminal connected to the second voltage applying unit 405. The switching unit 407 may be connected between the respective X electrode(s) (the first terminal(s) of the panel capacitors Cp) of the PDP 1 and ground, and may include a sixth switching device S6. The switching unit 407 may perform a switching operation in order to apply the sustain pulse output from the sustain pulse applying unit 40 to the respective X electrode(s) of the PDP 1 and may prevent the second voltage Vb, which may be output from the second voltage applying unit 405, from flowing to the sustain pulse applying unit 410. More particularly, e.g., the sixth switching device S6 may be turned on in order to supply the sustain pulse to the respective X electrode(s) (the first terminal(s) of the panel capacitors Cp) of the PDP, and may be turned off in order to prevent the second voltage Vb from flowing to the sustain pulse applying unit 40.

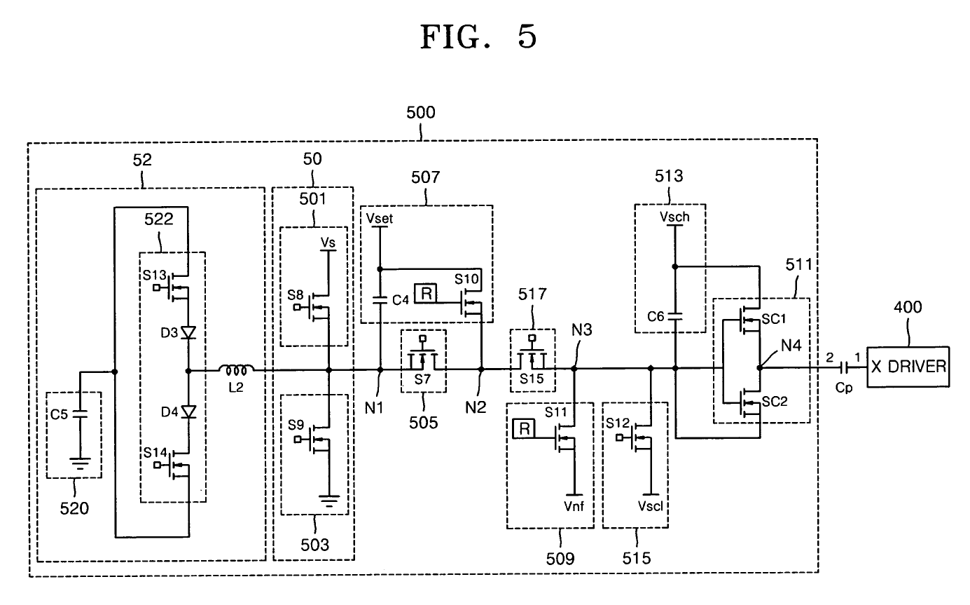

FIG. 5 illustrates a circuit diagram of an exemplary Y driver 500 of the apparatus for driving the PDP 1 illustrated in FIG. 3 according to an exemplary embodiment of the present invention.

Referring to FIG. 5, Y driver 500 may include a sustain pulse applying unit 50, a first switching unit 505, a second switching unit 517, a tenth voltage applying unit 507, a fifth voltage applying unit 509, a scan switching unit 511, a sixth voltage applying unit 513, a seventh voltage applying unit 515, and an energy recovery unit 52 in order to output a respective driving signal to the respective Y electrode(s) (second terminal(s) of the panel capacitors Cp).

The sustain pulse applying unit 50 may include a ninth voltage applying unit 501 that may output a ninth voltage Vs to a first node N1, and a first voltage applying unit 503 that may output the first voltage Vg, e.g., a ground voltage, to the first node N1. The first switching unit 505 may include a seventh switching device S7 having one terminal connected to the first node N1 and another terminal connected to a second node N2. The second switching unit 517 may include a fifteenth switching device S15 having one terminal connected to the second node N2 and another terminal connected to a third node N3. The tenth voltage applying unit 507, which may be connected between the first node N1 and the second node N2, may gradually increase a third voltage Vs that may be the same as the ninth voltage Vs to the level of a tenth voltage Vset, and may output the third voltage Vs to the second node N2. That is, in the following description, it will be assumed that the ninth voltage Vs is the same as the third voltage Vs.

The fifth voltage applying unit 509, which may be connected between the third node N3, may gradually lower the third voltage Vs to a level of a fifth voltage Vnf, and outputs the third voltage Vs to the third node N3. The scan switching unit 511 may include a first scan switching device SC1 and a second scan switching device SC2, which may be serially connected to each other.

A fourth node N4, which may be disposed between the first scan switching device SC1 and the second scan switching device SC2, may be connected to the Y electrode(s) (the second terminal(s) of the panel capacitors Cp) of the PDP. The sixth voltage applying unit 513 may include a sixth capacitor C6 and may be connected to a sixth voltage source and the first scan switching device SC1, and may output a sixth voltage Vsch to the first scan switching device SC1.

The seventh voltage applying unit 515 may be connected to the third node N3 and the second scan switching device SC2 and may output a seventh voltage Vscl. The energy recovery unit 52 may accumulate charges in the panel capacitor Cp and/or store charges in the respective panel capacitor Cp.

The ninth voltage applying unit 501 may include an eighth switching device S8 having one terminal connected to a ninth voltage source and another terminal connected to the first node N1. The first voltage applying unit 503 may include a ninth switching device S9 having one terminal connected to ground and another terminal connected to the first node N1. The sustain pulse applying unit 50, which may include the ninth voltage applying unit 501 and the first voltage applying unit 503, may alternatively turn on the eighth switching device S8 and the ninth switching device S9 in order to generate a sustain pulse.

The tenth voltage applying unit 507 may include a fourth capacitor C4 and a tenth switching device S110. One terminal of the fourth capacitor C4 may be connected to the first node N1 and another terminal thereof may be connected to a tenth voltage source, which may supply a tenth voltage Vset. The tenth switching device S10 may be connected between the tenth voltage source and the second node N3.

If the seventh switching device S7 of the first switching unit 505 is turned off, the fifteenth switching device S15 of the second switching unit 617 is turned on, the eighth switching device S8 of the first voltage applying unit 601 and the tenth switching device S10 of the third voltage applying unit 607 are turned on, a voltage corresponding to the third voltage Vs may be passed to the fourth capacitor C4, and a voltage at the third node N3 may gradually rise to a fourth voltage Vset+Vs.

The fifth voltage applying unit 509 may include an eleventh switching device S11 having one terminal connected to the third node N3 and another terminal connected to a fifth voltage source, which may supply the fifth voltage Vnf. If the eighth switching device S8 of the ninth voltage applying unit 501, the seventh switching device S7 of the first switching unit 505, the fifteenth switching device S115 of the second switching unit 517, and the eleventh switching device S11 of the fifth voltage applying unit 509 are turned on, a voltage at the third node N3 may gradually fall from the level of the third voltage Vs to the level of the fifth voltage Vnf.

The seventh voltage applying unit 515 may include a twelfth switching device S12 connected between the third node N3 and may be connected the seventh voltage source, which may supply the seventh voltage Vscl. If the twelfth switching device S12 is turned on, the seventh voltage Vscl may be output to the third node N2.

If the first scan switching device SC1 of the scan switching unit 511 is turned on and the second scan switching device SC2 of the scan switching unit 511 is turned off, the sixth voltage Vsch may be output to the Y electrode(s) (the second terminal(s) of panel capacitors Cp) through the fourth node N4. If the first scan switching device SC1 of the scan switching unit 511 is turned off and the second scan switching device SC2 thereof is turned on, each voltage output to the third node N3, e.g., the third voltage Vs, the ground voltage Vg, the fourth voltage Vs+Vset, the fifth voltage Vnf, and the seventh voltage Vscl, may be output to the Y electrode(s) (the second terminal(s) of panel capacitors Cp) through the fourth node N4.

The energy recovery unit 52 may include an energy storage unit 520, an energy recovery switching unit 522, and an inductor L2. The energy storage unit 520 may store charges from the panel capacitors Cp. The energy recovery switching unit 522 may be connected to the energy storage unit 520, and may control the charges stored in the energy storage unit 520 that may be accumulated in the panel capacitors Cp or charges of the panel capacitors Cp to be stored in the energy storage unit 520. One terminal of the inductor L2 may be connected to the energy recovery switching unit 522 and another terminal of the inductor L2 may be connected to the first node N1.

The energy storage unit 520 may include a fifth capacitor C5 for storing the charges of the panel capacitors Cp.

The energy recovery switching unit 522 may include a thirteenth switching device S13 and a fourteenth switching device S14 each having one terminal connected to the energy storage unit 520 and another terminal connected to the inductor L2. Third and fourth diodes D3 and D4 may be connected in different directions relative to the inductor L2, between the thirteenth switching device S13 and the fourteenth switching device S14.

Exemplary operation of the energy recovery unit 52 will be described below under the condition that the seventh switching device S7 of the first switching unit 505 and the second scan switching device SC2 of the scan switching unit 511 are turned on. If the fourteenth switching device S14 of the energy recovery switching unit 522 is turned on, the charges of the respective panel capacitor(s) Cp may be stored in the fifth capacitor C5 through the inductor L2, the fourth diode D4, and the fourteenth switching device S14. If the thirteenth switching device S13 of the energy recovery switching unit 522 is turned on, the charges stored in the fifth capacitor C5 may be stored in the respective panel capacitor(s) Cp through the thirteenth switching device S13, the third diode D3, and the inductor L2.

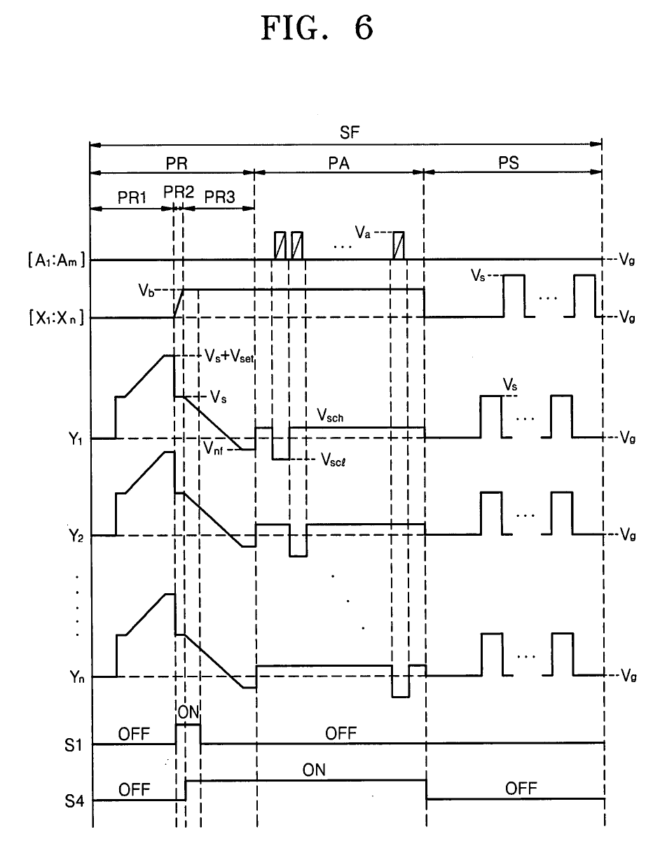

FIG. 6 illustrates a timing and waveform diagram of exemplary driving signals and driving switching signals that may be supplied to electrodes using a method of driving a plasma display apparatus according to an exemplary embodiment of the present invention.

Referring to FIG. 6, a unit frame for driving, e.g., the PDP 1 of FIG. 1 may be divided into a plurality of subfields SFs, and each subfield SF may be divided into a reset period PR, an address period PA, and a sustain period PS.

During the reset period PR, all of the discharge cells may be initialized. The reset period PR may be divided into a first reset period PR1, a second reset period PR2, and a third reset period PR3.

During the reset period PR, the first voltage Vg may be applied to the address electrodes A1 through Am.

During the first reset period PR1, the first voltage Vg, e.g., a ground voltage, may be applied to the X electrodes X1 through Xn, and, for a predetermined period of time of the first reset period PR1, the first voltage Vg may be applied to the Y electrodes Y1 through Yn. Then, a ramp pulse waveform voltage that continues to rise from the third voltage, e.g., the ninth voltage Vs, to the fourth voltage Vs+Vset may be applied to the Y electrodes Y1 through Yn.

During the second reset period PR2, a ramp pulse waveform voltage that continues to rise from the first voltage Vg to the second voltage Vb may be applied to the X electrodes X1 through Xn, and the third voltage Vs may be applied to the Y electrodes Y1 through Yn.

During the third reset period PR3, the X electrodes X1 through Xn may be biased with the second voltage Vb, and a ramp pulse waveform voltage that continues to fall from the third voltage Vs to the fifth voltage Vnf may be applied to the Y electrodes Y1 through Yn.

More particularly, during the second reset period PR2, the ramp pulse waveform voltage that continues to rise from the first voltage Vg to the second voltage Vb may be applied to the X electrodes X1 through Xn by applying the charges stored in the energy recovery circuit 42 illustrated in FIG. 4 to the X electrodes X1 through Xn.

During the second reset period PR2, the first switching device S1 illustrated in FIG. 4, which may control the charges stored in the energy storage unit 420 of the energy recovery circuit 42, may be turned on and may enable the charges stored in the energy recovery circuit 42 to be applied to the panel capacitors Cp. In some embodiments, the first switching device S1 may be maintained on during an initial predetermined time of the third reset period PR3, and may be turned off for a remainder of the third reset period PR3. The first switching device S1 may be maintained off during the address period PA and the sustain period PS.

The fourth switching device S4 illustrated in FIG. 4, which is connected to the second voltage source and may control application of the second voltage Vb to the X electrodes X1 through Xn, may be turned off during the first reset period PR1 and the second reset period PR2, and may be turned on during the third reset period PR3.

The exemplary embodiment described above with regard to FIG. 6, may enable an amount of hard switching current corresponding to the second voltage Vb applied to the X electrodes X1 through Xn, reactive power consumption and/or electromagnetic interference (EMI) to be reduced.

During the address period PA, discharge cells in which a sustain discharge is to occur during a subsequent sustain period PS may be selected. During the address period PA, the second voltage Vb may be continuously applied to the X electrodes, X1 through Xn, scan pulses may be sequentially applied to the Y electrodes Y1 through Yn, and a display data signal may be applied to the address electrodes A1 through Am in synchronization with the scan pulses so that an address discharge may be executed. Each of the scan pulses may correspond to a drop from the sixth voltage Vsch to the seventh voltage Vscl, which is lower than the sixth voltage Vsch. More particularly, during the address period PA, as shown in FIG. 6, the Y electrodes Y1 through Yn may be supplied with the sixth voltage Vsch and then, in accordance with display data signals supplied to the respective address electrode(s) A1 through Am a voltage applied to the respective Y electrode(s) may be dropped to the seventh voltage Vscl. For example, the display data signal(s) may have a positive eighth voltage Va synchronized with an application of the seventh voltage Vscl of a corresponding scan pulse.

During the sustain period PS, sustain pulses may be alternately applied to the X electrodes X1 through Xn and the Y electrodes Y1 through Yn, so that a sustain discharge may be performed. Brightness of a unit field including a plurality of subfields SFs may correspond to execution of a sustain discharge during each of the subfields SFs and based on gray level weights allocated to each of the subfields SFs. The sustain pulses may alternate between the level of the ninth voltage Vs and the level of the first voltage Vg. As discussed above, in the exemplary embodiments described herein, the ninth voltage Vs is assumed to be the same as the third voltage Vs.

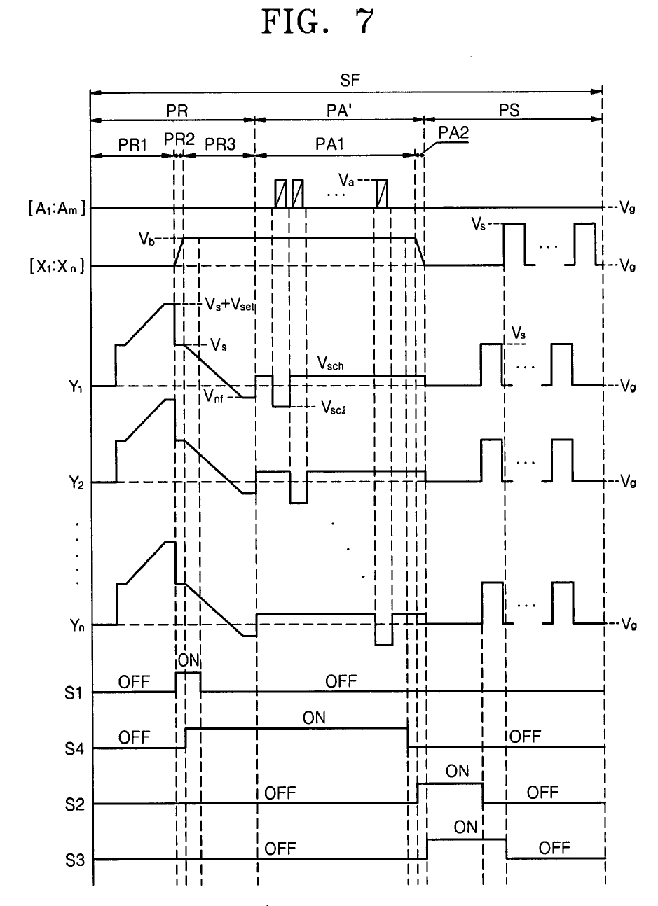

FIG. 7 illustrates a timing and waveform diagram of exemplary driving signals and driving switching signals that may be supplied to electrodes using a method of driving a plasma display apparatus according to another exemplary embodiment of the present invention.

Only differences between the exemplary embodiment illustrated in FIG. 7 and the exemplary embodiment illustrated in FIG. 6 will be described. Referring to FIG. 7, an address period PA′ may include a first address period PA1 and a second address period PA2.

During the first address period PA1, the X electrodes X1 through Xn may be biased with the second voltage Vb.

During the second address period PA2, a ramp pulse waveform voltage that continues to fall from the second voltage Vb to the first voltage Vg may be applied to the X electrodes X1 through Xn by recovering the charges stored in the respective panel capacitor(s) Cp with the energy recovery circuit 42 illustrated in FIG. 4.

The second switching device S2 illustrated in FIG. 4, which may control the charges stored in the panel capacitors Cp to be stored in the energy storage unit 420, may be turned on during the second address period PA2. As shown in FIG. 7, in some embodiments of the invention, the second switching device S2 may be maintained off during the reset period PR and the first address period PA1, may be turned on during the second address period PA2, may be maintained on during an initial predetermined portion of the sustain period PS.

The third switching device S3 illustrated in FIG. 4 may be turned off during the address period PA, and may be turned on during an initial predetermined portion of the sustain period PS, e.g., while the first voltage Vg is initially applied to all the X electrodes X1 through Xn.

In some embodiments of the invention, the fourth switching device S4 may be turned on during the second reset period PR2, may be maintained on during the third reset period PR3, may be maintained on during the first address period PA1 to a predetermined point before the second address period PA2, and may be turned off during a remainder of the first address period PA1, the second address period PA2, and the sustain period PS.

The exemplary embodiment described above with regard to FIG. 7, may serve as another exemplary embodiment of a method of driving a display that may enable an amount of a hard switching current corresponding to the second voltage Vb applied to the X electrodes X1 through Xn, reactive power consumption and/or EMI to be reduced.

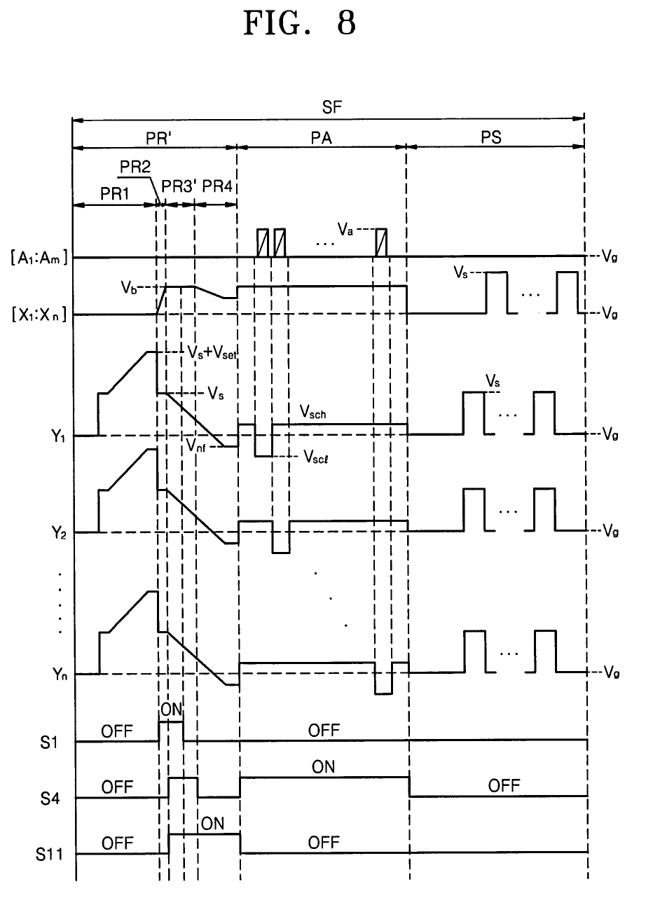

FIG. 8 illustrates a timing and waveform diagram of exemplary driving signals and driving switching signals that may be supplied to electrodes using a method of driving a plasma display apparatus according to another exemplary embodiment of the present invention. In the following description, in general, only the differences between the exemplary embodiment illustrated in FIG. 8 and the exemplary embodiment illustrated in FIG. 6 will be described below.

Referring to FIG. 8, similar to the exemplary embodiments described above with regard to FIGS. 6 and 7, a unit frame for driving the PDP 1 of FIG. 3 may be classified into a plurality of subfields SFs, and each subfield SF may include a reset period PR′, the address period PA, and the sustain period PS.

The reset period PR′, during which all of the discharge cells may be initialized, may be divided into the first reset period PR1, the second reset period PR2, a third reset period PR3′, and a fourth reset period PR4.

During the first reset period PR1, the first voltage Vg, e.g., a ground voltage, may be applied to the X electrodes X1 through Xn, and the first voltage Vg may also be applied to the Y electrodes Y1 through Yn during a predetermined period of time of the first reset period PR1 before a ramp pulse waveform voltage that continues to rise from the third voltage Vs to the fourth voltage Vs+Vset may be applied to the Y electrodes Y1 through Yn.

During the second reset period PR2, a ramp pulse waveform voltage that continues to rise from the first voltage Vg to the second voltage Vb may be applied to the X electrodes X1 through Xn, and the third voltage Vs may be applied to the Y electrodes Y1 through Yn.

During the third reset period PR3′ and the fourth reset period PR4, a ramp pulse waveform voltage that continues to fall from the third voltage Vs to the fifth voltage Vnf may be applied to the Y electrodes Y1 through Yn and the eleventh switching device S11, illustrated in FIG. 5 as connected to the fifth voltage source, may be turned on.

During the third reset period PR3′, the X electrodes X1 through Xn may be biased with the second voltage Vb. During the fourth reset period PR4, a voltage may not be applied to the X electrodes X1 through Xn and the X electrodes X1 through Xn may be electrically floating.

Referring to FIG. 8, while the X electrodes X1 through Xn may be in an electrically floating state during the fourth reset period PR4, a voltage having a similar pattern to the voltage applied to the Y electrodes Y1 through Yn may be output from the X electrodes X1 through Xn as a result of coupling of the X electrodes X1 through Xn and the Y electrodes Y1 through Yn.

During the reset period PR′, the first voltage Vg may be applied to the address electrodes A1 through Am.

During the second reset period PR2, a ramp pulse waveform voltage that continues to rise from the first voltage Vg to the second voltage Vb may be applied to the X electrodes X1 through Xn by applying the charges stored in the energy recovery circuit 42 illustrated in FIG. 4 to the X electrodes X1 through Xn.

Accordingly, the first switching device S1 illustrated in FIG. 4, which may control the charges stored in the energy storage unit 420 of the energy recovery circuit 42 to be applied to the panel capacitors Cp, may be turned on during the second reset period PR2. In some embodiments of the invention, the first switching device S1 may be maintained on during an initial predetermined portion of the second reset period PR2.

The fourth switching device S4 illustrated in FIG. 4, which is connected to the second voltage source and may control the second voltage Vb to be applied to the X electrodes X1 through Xn, may be turned off during the first reset period PR1 and the second reset period PR2, may be turned on during the third reset period PR3, and may be turned off during the fourth reset period PR4.

The exemplary embodiment described above with regard to FIG. 8, may serve as another exemplary embodiment of a method of driving a display that may enable an amount of a hard switching current corresponding to the second voltage Vb applied to the X electrodes X1 through Xn, reactive power consumption and/or EMI may be reduced.

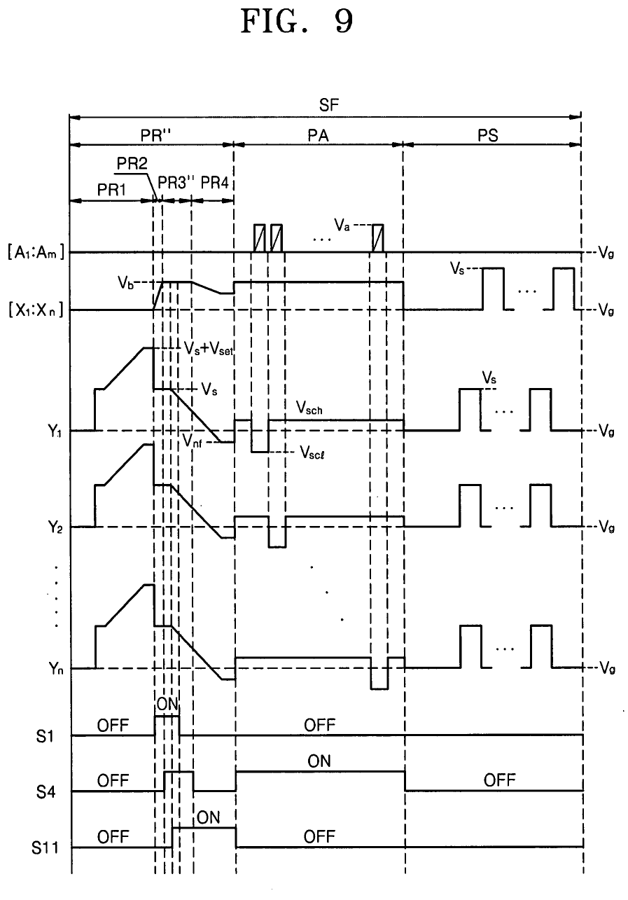

FIG. 9 illustrates a timing and waveform diagram of exemplary driving signals and driving switching signals that may be supplied to electrodes using a method of driving a plasma display apparatus according to another exemplary embodiment of the present invention.

Only differences between the exemplary embodiment illustrated in FIG. 9 and the exemplary embodiment illustrated in FIG. 8, will be described below. More particularly, referring to FIGS. 8 and 9, the driving signals applied to the Y electrodes Y1 through Yn during the reset period PR′ of the exemplary embodiment illustrated in FIG. 8 are different than the driving signals applied to the Y electrodes Y1 through Yn during the reset period PR″ of the exemplary embodiment illustrated in FIG. 9.

Referring to FIG. 9, during the first reset period PR1, the first voltage Vg may be applied to the Y electrodes Y1 through Yn during a predetermined period of time, and a ramp pulse waveform voltage that continues to rise from the third voltage Vs to the fourth voltage Vs+Vset may be applied to the Y electrodes Y1 through Yn. The third voltage Vs may be applied to the Y electrodes Y1 through Yn during the second reset period PR2 and an initial predetermined portion of a third reset period PR3″. A ramp pulse waveform voltage that continues to fall from the third voltage Vs to the fifth voltage Vnf may be applied to the Y electrodes Y1 through Yn during a last stage of the third reset period PR3″ and the fourth reset period PR4 by turning on the eleventh switching device S11 illustrated in FIG. 5, which may be connected to the fifth voltage source.

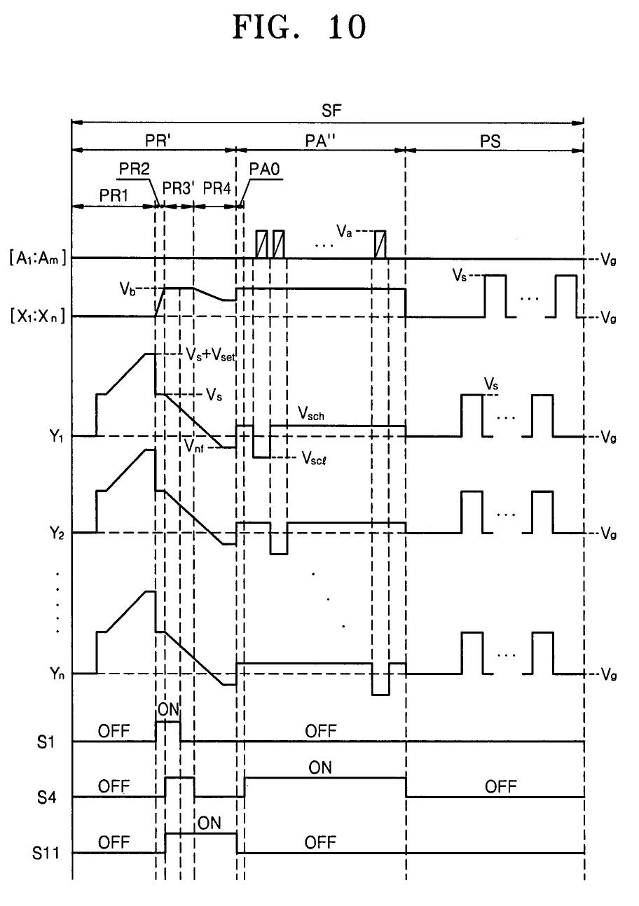

FIG. 10 illustrates a timing and waveform diagram illustrating exemplary driving signals and driving switching signals that may be supplied to electrodes using a method of driving a plasma display apparatus according to another exemplary embodiment of the present invention. Only differences between the exemplary embodiment illustrated in FIG. 10 and the exemplary embodiment illustrated in FIG. 8 will be described below.

More particularly, in the exemplary embodiment illustrated in FIG. 10, the X electrodes X1 through Xn and the X electrodes X1 through Xn are maintained in an electrically floating state, i.e., no voltage is applied thereto, through an initial predetermined portion of an address period PA0.

During the third reset period PR3′ and the fourth reset period PR4, a ramp pulse waveform voltage that continues to fall from the third voltage Vs to the fifth voltage Vnf may be applied to the Y electrodes Y1 through Yn. During the address period PA″, a scan pulse having the seventh voltage Vscl may be applied to the Y electrodes Y1 through Yn, which may be biased with a sixth voltage Vsch. During the fourth reset period PR4 and an initial stage predetermined portion of the address period PA″, a voltage may not be applied to the X electrodes X1 through Xn and the X electrodes X1 through Xn may be electrically floating before the second voltage Vb may be applied to the X electrodes X1 through Xn.

The exemplary voltage application waveform is described below with regard to a switching operation of the fourth and eleventh switching devices S4, S11. The eleventh switching device S11 illustrated in FIG. 5 as connected to the fifth voltage source Vnf may be turned on during the third reset period PR3 and the fourth reset period PR4, and may be turned off during the address period PA″. The fourth switching device S4 illustrated in FIG. 4, which may be connected to a second voltage source and may control the second voltage Vb to be applied to the X electrodes X1 through Xn, may be turned off during the fourth reset period PR4 and a predetermined initial portion of the address period PA″, and may be turned on after the predetermined initial portion of the address period PA″ has lapsed. Further, as shown in FIG. 10, in some embodiments of the invention, the fourth switching device S4 may be turned on a predetermined period of time after the eleventh switching device S11 is turned off.

The exemplary embodiment described above with regard to FIG. 10, may enable an amount of a hard switching current corresponding to the second voltage Vb applied to the X electrodes X1 through Xn, to be reduced more than that of the embodiments illustrated in FIGS. 8 and 9.

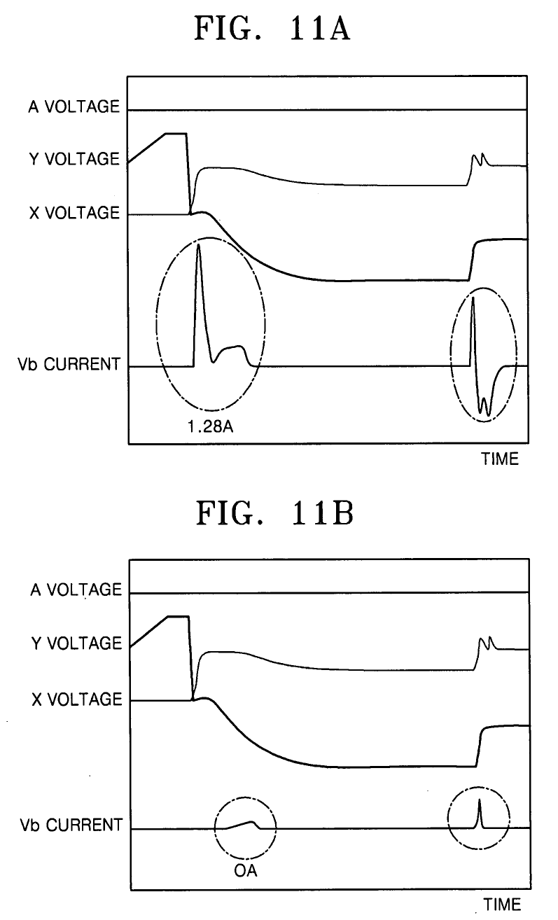

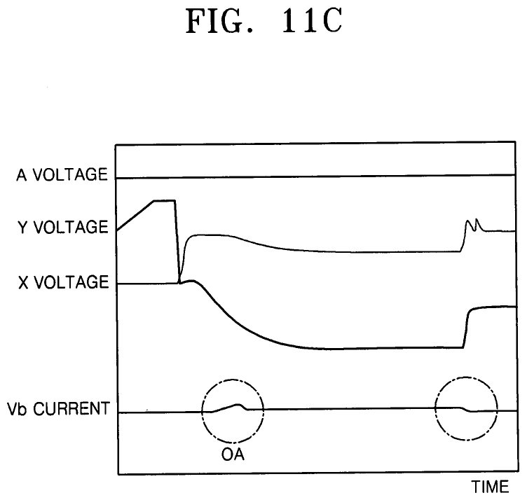

FIG. 11A illustrates a graph of a result obtained by measuring an amount of a hard switching current corresponding to a second voltage Vb using a conventional method of driving a plasma display apparatus. FIG. 11B illustrates a graph of a result obtained by measuring an amount of a hard switching current corresponding to a second voltage Vb using the exemplary methods of driving a plasma display apparatus illustrated in FIGS. 6 and 8. FIG. 1C illustrates a graph of a result obtained by measuring an amount of a hard switching current corresponding to a second voltage Vb using the exemplary method of driving a plasma display apparatus illustrated in FIG. 10.

Referring to FIGS. 11A and 11B, the methods of driving the plasma display apparatus illustrated in FIGS. 6 and 8 may reduce an amount of the hard switching current corresponding to the second voltage Vb applied to the X electrodes X1 through Xn as compared to the conventional method, and may thereby reduce EMI.

Referring to FIG. 11C, the method of driving the plasma display apparatus illustrated in FIG. 10 may further reduce the size of the hard switching current corresponding to the second voltage Vb applied to the X electrodes X1 through Xn as compared to the conventional method and the exemplary methods illustrated in FIGS. 6 and 8, and may thereby further reduce EMI.

Embodiment of methods of driving a plasma display apparatus according to one or more aspects of present invention may reduce an amount of a hard switching current corresponding to a voltage applied to X electrodes during a reset period or an address period, and may reduce reactive power consumption and EMI.

While the present invention has been particularly shown and described with reference to exemplary embodiments thereof, it will be understood by those of ordinary skill in the art that various changes in form and details may be made therein without departing from the spirit and scope of the present invention as defined by the following claims. Exemplary embodiments of the present invention have been disclosed herein, and although specific terms are employed, they are used and are to be interpreted in a generic and descriptive sense only and not for purpose of limitation.

What is claimed is:

1. A method of driving a plasma display apparatus to display an image during a frame including a plurality of subfields, each subfield including a reset period, an address period and a sustain period, the display apparatus including a panel including X and Y electrodes, an electrode driver adapted to supply driving signals the X and Y electrodes and including an energy recovery circuit, the method comprising:
supplying a first voltage to the X electrodes during a first reset period of the reset period;
supplying, using energy stored in the energy recovery circuit, a ramp waveform voltage that rises from the first voltage signal to a second voltage to the X electrodes during a second reset period of the reset period;
biasing the X electrodes with the second voltage during at least a first sub-period of a third reset period of the reset period;
supplying a ramp pulse waveform voltage that rises from a third voltage to a fourth voltage to the Y electrodes during a second portion of the first reset period; and
supplying a ramp pulse waveform voltage that falls from the third voltage to a fifth voltage to the Y electrodes during the third reset period.

2. The method as claimed in claim 1, further comprising supplying the first voltage to the Y electrodes during a first portion of the first reset period that precedes the second portion of the first reset period.

3. The method as claimed in claim 1, further comprising supplying the third voltage to Y electrodes during the second reset period.

4. The method as claimed in claim 1, wherein the energy recovery circuit comprises an energy storage unit that stores charges of the panel, a first switching device adapted to controllably supply the charges stored in the energy storage unit to the panel, and a second switching device adapted to controllably supply the charges stored in the panel to the energy storage unit, and the method further includes:
turning on the first switching device during the second reset period.

5. The method as claimed in claim 1, wherein the electrode driver comprises a first voltage source, a third switching device that is connected to the first voltage source and controls a supply of the first voltage to the X electrodes, a second voltage source, and a fourth switching device connected to the second voltage source and controls a supply of the second voltage the X electrodes, and the method further includes:
turning off the fourth switching device during the first and second reset periods, and
turning on the fourth switching device during the third reset period.

6. The method as claimed in claim 1, wherein the address period comprises a first address period during which the X electrodes are biased with the second voltage, and a second address period, and the method further includes supplying, during the second address period and using the energy recovery circuit, a ramp waveform voltage that falls from the second voltage to the first voltage to the X electrodes.

7. The method as claimed in claim 6, wherein the energy recovery circuit comprises an energy storage unit that stores charges of the panel, a first switching device adapted to controllably supply the charges stored in the energy storage unit to the panel, and a second switching device adapted to controllably supply the charges stored in the panel to the energy storage unit, and the method further includes turning on the second switching device during the second reset period.

8. The method as claimed in claim 7, wherein the second switching device is turned on during an initial portion of the sustain period when the first voltage is being applied to the Y electrodes.

9. The method as claimed in claim 6, wherein the electrode driver comprises a first voltage source, a third switching device that is connected to the first voltage source and controls a supply of the first voltage to the X electrodes, a second voltage source, and a fourth switching device connected to the second voltage source and controls a supply of the second voltage to the X electrodes, and the method further includes:
turning off the third switching device during the address period;
turning on the third switching device during a second initial predetermined portion of the sustain period;
turning on the fourth switching device during a predetermined portion of the first address period; and
turning off the fourth switching device before completion of the first address period, and maintaining the fourth switching device in an off state through a remainder of the first address period, the second address period, and the sustain period.

10. The method as claimed in claim 9, wherein the second initial predetermined portion of the sustain period is a period during which the first voltage is applied to the X electrodes.

11. The method as claimed in claim 1, further comprising maintaining the X electrodes in an electrically floating state during a second sub-period of the third reset period.

12. The method as claimed in claim 11, wherein maintaining the X electrodes in an electrically floating state comprises not supplying a voltage to the X electrodes during the second sub-period of the third reset period.

13. The method as claimed in claim 11, wherein the energy recovery circuit comprises an energy storage unit that stores charges of the panel, and a switching device adapted to controllably supply the charges stored in the energy storage unit to the panel, and the method further includes turning on the switching device during the second reset period.

14. The method as claimed in claim 11, further comprising maintaining the X electrodes in the electrically floating state during an initial predetermined portion of the address period.

15. The method as claimed in claim 11, wherein the electrode driver comprises a switching device connected to a second voltage source and adapted to control a supply of the second voltage to the X electrodes, and the method further comprises turning off the switching device during the first reset period, the second reset period, and the second sub-period of the third reset period.

16. The method as claimed in claim 3, further comprising supplying the third voltage to the Y electrodes during an initial predetermined portion of the first sub-period of the third reset period, the initial predetermined portion of the first sub-period of the third reset period immediately following the second reset period.

17. The method as claimed in claim 11, wherein supplying the ramp pulse waveform voltage that falls from the third voltage to the fifth voltage comprises supplying the ramp pulse waveform voltage that falls from the third voltage to the fifth voltage during the first sub-period and the second sub-period of the third reset period, and the method further including, during the address period:
supplying a scan pulse having a seventh voltage to the Y electrodes, which are biased with a sixth voltage; and
supplying the second voltage to the X electrodes after the initial predetermined portion of the address period.

18. A method of driving a plasma display apparatus to display an image during a frame including a plurality of subfields, each subfield including a reset period, an address period and a sustain period, the address period including a first address period and a second address period, the display apparatus including X and Y electrodes, an electrode driver adapted to supply driving signals the X and Y electrodes and including an energy recovery circuit, the method comprising:
biasing the X electrodes with a biasing voltage during the first address period; and
supplying, during the second address period and using the energy recovery circuit, a ramp waveform voltage that falls from the biasing voltage to a first voltage to the X electrodes.

19. A method of driving a plasma display apparatus to display an image during a frame including a plurality of subfields, each subfield including a reset period, an address period and a sustain period, the address period including a first address period and a second address period, the display apparatus including X electrodes, an electrode driver adapted to supply driving signals the X electrodes and including an energy recovery circuit, the method comprising:
supplying a first voltage to the X electrodes during a first reset period of the reset period; and
at least one of:
supplying, using energy stored in the energy recovery circuit, a ramp waveform voltage that rises from the first voltage signal to a second voltage to the X electrodes during a second reset period of the reset period, and
biasing the X electrodes with the second voltage during at least a portion of the first address period, and supplying, during the second address period and using the energy recovery circuit, a ramp waveform voltage that falls from the second voltage to a first voltage to the X electrodes.

20. The method as claimed in claim 19, further comprising biasing the X electrodes with the second voltage during at least a portion of a third reset period of the reset period.
